(19) United States
(12) Patent Application Publication
(10) Pub. No.: US 2009/0017305 A1
(43) Pub. Date: Jan. 15, 2009

(54) MANUFACTURING PROCESS FOR INTEGRATED MICROELECTROMECHANICAL COMPONENTS

(76) Inventors: Franz Dietz, Untereisesheim (DE); Alida Wuertz, Marbach (DE)

Correspondence Address: Muncy, Geissler, Olds & Lowe, PLLC, P.O. BOX 1364, FAIRFAX, VA, 22038-1364, US

(21) Appl. No.: 12/181,299

(22) Filed: Jul. 28, 2008

Related U.S. Application Data
(63) Continuation of application No. PCT/EP2007/000526, filed on Jan. 23, 2007.

(30) Foreign Application Priority Data
Jan. 26, 2006 (DE) DE 102006003718.9

(51) Int. Cl. B32B 38/04; H01B 13/00

(52) U.S. Cl. 428/409; 216/17

(57) ABSTRACT

A method for producing integrated microelectromechanical components is provided, whereby a first conductive layer is produced on a first insulating layer, the first conductive layer is structured, a second insulating layer is produced, a second conductive layer is produced, at least one etch opening is produced for at least partial etching of the second insulating layer beneath the second conductive layer in order to produce at least one hollow space, and at least a part of the first conductive layer and the second conductive layer is electrically contacted.

This nonprovisional application is a continuation of International Application No. PCT/EP2007/000526, which was filed on Jan. 23, 2007, and which claims priority to German Patent Application No. DE 10 2006 003 718.9, which was filed in Germany on Jan. 26, 2006, and which are both herein incorporated by reference.

### BACKGROUND OF THE INVENTION

1. Field of the Invention

The present invention relates to a method for producing integrated microelectromechanical components and also to integrated microelectromechanical components.

2. Description of the Background Art

Microelectromechanical systems, MEMS, with which physical quantities such as pressure, force, acceleration, flow, etc. can be converted into an electrical signal, are known. Conversely, it is also known to convert electrical signals into mechanical motion, for example by deflection of a cantilevered membrane. The manufacture of different components, such as sensors, micromechanical switches, or signal sources, using technology such as is used for semiconductor manufacture, is known.

The IEEE Transactions on Ultrasonics, Ferroelectrics, and Frequency Control, vol. 45, no. 3, May 1998, for example, discloses a method in which an oxide layer of approximately 1 μm is initially deposited on both sides of a p-doped silicon layer by means of a wet process step. This is followed by a deposition (LPCVD) on both sides of a nitride layer with a thickness of 3500 Å. Then the etch openings are transferred into the nitride layer by means of an electron-beam lithographic process. Next, the nitride is etched using a plasma process, and the oxide layer, which serves as a sacrificial layer, is removed by means of hydrofluoric acid (HF) etching. After this, a second nitride layer with a thickness of 2500 Å is applied to the first nitride layer, which is now provided with openings, by which means the etched holes in the oxide layer are sealed under vacuum. Next, a chromium layer and a 500 Å thick gold layer are vapor-deposited on the wafer. After singulation of the components, the top and bottom electrodes are contacted.

This process has the disadvantage that the buried oxide layer is used as a sacrificial layer, and thus is at least partially removed again during the etching process. As a result, it cannot take on an insulating function with respect to the substrate. Moreover, it is necessary to contact the bottom electrode, which is synonymous with the silicon substrate material, over its entire area. In the case of integration of additional circuit components on the chip, this would affect their electrical properties. In general, relatively large parasitic capacitances occur in individual components in this case.

U.S. Pat. No. 6,563,106 B1 also discloses a method for manufacturing a MEMS component utilizing standard manufacturing processes from the semiconductor industry. However, in this method, electrically contacting the base plate makes it necessary to structure the back of the substrate and to produce electrodes surrounded by an oxide layer that is intended to serve as insulation.

### SUMMARY OF THE INVENTION

It is therefore an object of the present invention to provide a method with which microelectromechanical components can be manufactured simply and economically, and can be integrated together with the circuit components necessary for signal conditioning and processing using standard manufacturing processes.

In an embodiment, the following steps are provided, which can be in sequence, in a method for manufacturing microelectromechanical components. To start with, a first conductive layer is produced on a first insulating layer. This first conductive layer can include monocrystalline or polycrystalline silicon. Next, the first conductive layer is structured, wherein the spacing of the cantilevered membrane from the base plate in the microelectromechanical component is already determined here by the depth of the structuring. In the structuring, the first insulating layer is neither removed nor attacked, in order to ensure insulation from a substrate layer that may be located therebelow. Next, a second insulating layer is deposited as a sacrificial layer on the structured first conductive layer. The second insulating layer, which includes SiO₂, for example, insulates the conductive regions from one another.

Next, a second conductive layer, and subsequently at least one etch opening through which the second insulating layer can be at least partially etched, are produced on the second insulating layer. After the production of the etch opening, at least part of the first conductive layer and the second conductive layer are electrically contacted.

According to a further embodiment of the invention, the etch opening that is used to produce the hollow space in the second insulating layer is produced in the second conductive layer.

A method wherein the at least partial etching of the second insulating layer under the second conductive layer takes place after the electrical contacting of the first and second conductive layers has proven to be advantageous. In order to be able to fully integrate the production of MEMS in a standard process for IC production, for example an SOI (silicon on insulator) technology, the MEMS are separated by oxide trenches during the production of other components. The process sequence is chosen such that all other components, including the trace wiring, are produced first, and the etching of the second insulating layer to produce a hollow space takes place only thereafter. Since the second conductive layer corresponds to a membrane after the production of the hollow space, there would otherwise be a danger that the membrane would be damaged during further processing. As a result of the etching process, at least one hollow space is produced in at least portions of the second insulating layer, with the structure and shape of said hollow space being determined by the selection of the material of the second insulating layer and the etching solution and etching time. It is also possible to carry out etching that is not terminated by the etching time, wherein the etching is stopped vertically and laterally by the structured first conductive layer.

An embodiment of the invention provides that the at least one etch opening can be closed again in order to avoid the entry of unwanted materials in the hollow space.

Another embodiment provides that the first insulating layer can be produced on a substrate layer.

According to a further embodiment of the invention, the structuring of the first conductive layer can take place in multiple, staggered, steps, for example by an etching process. In the case of what is known as stepped back-etching, first a part of what is called a mask is removed, for example with the aid of a lithographic step, and then a first etching is performed. In a further step, another part of the remaining mask is then removed, exposing a new area for a second etching. In the second etching, the trenches produced by the first etching become deeper at the same time by the amount of the second etch depth. This sequence results in a staircase-like topography of the first conductive layer which can be used for a wide variety of microelectromechanical structures and components.

Another embodiment provides that the structuring of the first conductive layer involves subregions of this layer in the full thickness thereof to the first insulating layer. By structuring a deep trench that reaches down to the first insulating layer buried under the first conductive layer, subregions of the active first conductive layer can be separated from one another and thus can also be electrically insulated from one another.

Another embodiment provides that the production of the second insulating layer takes place in several sub-steps. In this process, the total thickness of the deposited layer essentially determines the height of the hollow space below the cantilevered structure. If trenches were produced down to the first insulating layer during the structuring of the first conductive layer, they are now filled with the insulating layer. This produces subregions that are electrically insulated from one another. This is particularly advantageous when additional circuit components are to be integrated together with the microelectromechanical components, which frequently require high operating voltages.

According to another embodiment of the invention, the first conductive layer can include a doped or highly doped semiconductor material. In this regard, material that is already doped can be used, or the doping of the semiconductor material can take place in an additional process step after the material for the first conductive layer has been deposited on the first insulating layer. Moreover, in order to produce conductive structures, the doping of the material for the first conductive layer can also take place after the structuring. A bottom electrode can be produced in this way. Alternatively, after the structuring it is also possible to deposit a conductive layer of another conductive material, such as metal, for example, which then forms a bottom electrode. Here, too, it is possible to create individual segments isolated from one another, which are electrically insulated from one another and thus can be separately contacted.

According to an embodiment of the invention, provision is made to level the surface of the second insulating layer after the production or deposition process. A chemical/mechanical method is suitable for this purpose.

Another embodiment provides that prior to deposition of the second conductive layer, an insulating layer is deposited that covers the second conductive layer, at least in subregions, and thus has a relatively large area. During later etching, the insulating layer is attacked, and channels are produced in these subregions under the second conductive layer. As a result, the second conductive layer, which constitutes a top cover layer, need not be structured; instead, the etching solution penetrates into the insulating layer laterally under the second conductive layer, exposes the channels, and in this way attacks the second insulating layer to produce a hollow space.

The etching of the second insulating layer can be interrupted in such a way that a part of the insulating layer stays behind on the walls surrounding the hollow space that is produced, and thus forms an insulating layer with respect to the first conductive layer. Following the etching, the etching solution is typically removed from the hollow space in a rinsing and thermal step.

Another embodiment of the invention provides that after the production of a hollow space in the second insulating layer, a passivation of the hollow space takes place through introduction of a gas or a liquid through the etch openings. Such a passivation layer prevents a short circuit between the second conductive layer and the first conductive layer in the event of a mechanical contact with a deformed cantilevered membrane.

A further embodiment of the invention provides that a defined internal pressure is produced in the hollow spaces during the closing of the etch openings; this internal pressure, since it is also retained there, provides a defined reference pressure for pressure measurements with the microelectromechanical element, so that the component can be used as an absolute pressure sensor with reproducible properties in both gases and liquids.

According to another embodiment of the invention, additional material can be deposited on the second conductive layer at a later time after the closure of the etch openings. By this means, the mass of the cantilevered structure is increased, and the mechanical behavior of the component can be affected in a targeted manner. In this way it is also possible to produce an immovable or nearly immovable cover plate, which serves as a reference structure for sensing a difference signal in order to eliminate parasitic effects. The capacitance of such a stiff structure is then independent or only slightly dependent on the physical quantity to be measured, such as the ambient pressure, for example.

In addition, the invention also includes a microelectromechanical component with at least two insulating layers and at least two conductive layers, wherein one conductive layer is arranged on an insulating layer in each case. In addition, at least one membrane is provided, which is located above at least one hollow space, wherein the hollow space is located at least partially in the second insulating layer.

The membrane can be designed to be large in area and movable. With the aid of the bottom electrode, which can also be designed to be large in area, the membrane then can either be deflected, for example to function as an ultrasonic source, or a membrane deflection can be detected capacitively. In the latter case, the microelectromechanical component can be used as a pressure or sound sensor, for example.

It can be advantageous for integration into standard production processes for the electrical contacting of the two conductive layers, hence the top and bottom electrodes, to take place from the same side, preferably from the top of the wafer.

In order to obtain an adequately large summation signal, it has proven to be advantageous to connect several microelectromechanical components into an array. To this end, connections are provided in the conductive layers, meshing the individual components in a grid-like manner. In this regard, different geometric forms, for example square or hexagonal grids, are possible. The shape of the individual electrodes is also variable, so that designs with round, square, hexagonal or octagonal shapes are possible.

MEMS components are especially suited for acoustic and ultrasonic transducers, which have a wide range of applications for distance measurements in a great variety of technical fields. They can be used for imaging methods in medical technology, for occupant detection in motor vehicles, in microphones, for flow measurements in pipes, or for nondestructive material testing, to name only a few possibilities.

As a matter of course, the features mentioned above and those described below need not be used in the specific combination given, but may also be used in other combinations or alone without departing from the scope of the invention.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIGS. 1a to 1g each show a cross-sectional view of a sequence of process steps for producing microelectromechanical components according to a first embodiment.

FIGS. 2a to 2g each show a cross-sectional view of a sequence of process steps for producing microelectromechanical components according to a second embodiment.

FIGS. 3a to 3f each show a cross-sectional view of a sequence of process steps for producing microelectromechanical components according to a third embodiment.

FIGS. 4a to 4h each show a cross-sectional view of a sequence of process steps for producing microelectromechanical components according to a fourth embodiment.

FIG. 5 shows a top view of a microelectromechanical component according to a fifth embodiment.

FIG. 6 shows a cross-section through a microelectromechanical component according to the embodiment in FIG. 5.

FIG. 7 shows a top view of multiple microelectromechanical components that are connected into an array.

### DETAILED DESCRIPTION

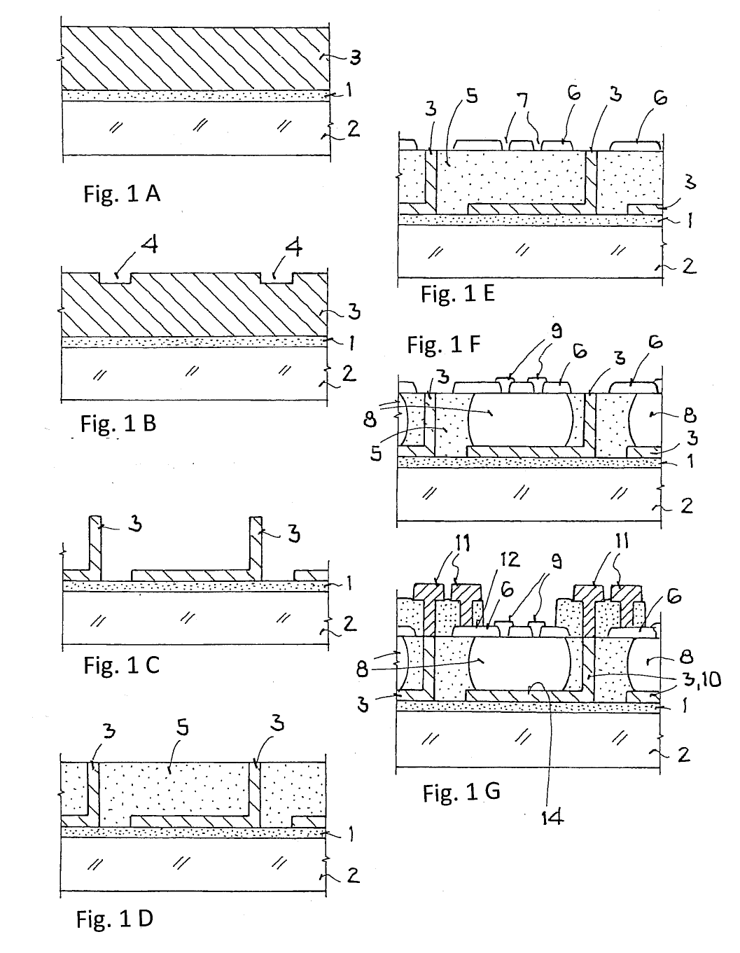

FIG. 1a shows a section through a semiconductor material with a first buried insulating layer 1. Applied to a substrate layer 2 is the first insulating layer 1, for example made of SiO₂, upon which a first conductive layer 3 has been deposited in turn. As is shown in FIGS. 1b and 1c, the first conductive layer 3 is partially removed again by structuring back-etching. In the present example embodiment, the back-etching takes place in several staggered steps. First, a part of what is called a mask (not shown) is removed, for example by means of a lithographic step. After that, a first etching takes place until the state of the first conductive layer 3 shown in FIG. 1b is reached. Next, an additional part of the remaining mask is removed in an additional step, thus exposing a new area of the first conductive layer 3 for etching. In the second etching step, the trenches 4 produced by the first etching become deeper at the same time by the amount of the second etch depth. This staggering of multiple etching steps results in a staircase-like topography. If the material used for the first conductive layer 3 was not doped, it can still be doped at this point in the process. Alternatively, at this point in time another conductive material, for example a metal layer, can be deposited and structured in order to produce a conductive layer over the first insulating layer 1.

Next, as shown in FIG. 1d, a second insulating layer 5, which serves as a sacrificial layer, is deposited on the structured first conductive layer 3. This can take place in several sub-steps. Thereafter, as is evident in FIG. 1e, a second conductive layer 6, which represents the upper cover layer here, is deposited on the second insulating layer 5. This second conductive layer can include a doped or highly-doped semiconductor material. It is advantageous for this to be a fatigue-free, single-crystal material. Alternatively, the use of polycrystalline materials is also possible.

The structuring of the second conductive layer 6 takes place next, forming the etch openings 7 that permit etching of the second insulating layer 5 under the second conductive layer 6.

FIG. 1f shows a process step in which a hollow space 8 has already been created in the second insulating layer 5 by the etching process, and the etch openings 7 have been closed with a third layer 9. Care was taken during the etching to ensure that an insulating layer 10 for the structured first conductive layer 3 remains on the side walls of the hollow space 8.

Next, as shown in FIG. 1g, there are produced the electrical contact 11 for the top electrode 12, which includes the second conductive layer 6, and for the bottom electrode 14, which includes the first conductive layer 3. In this regard, the metallization layers that form the electrical contact 11 are customarily surrounded at the surface by a cover layer of oxide, nitride, polyimide, or the like.

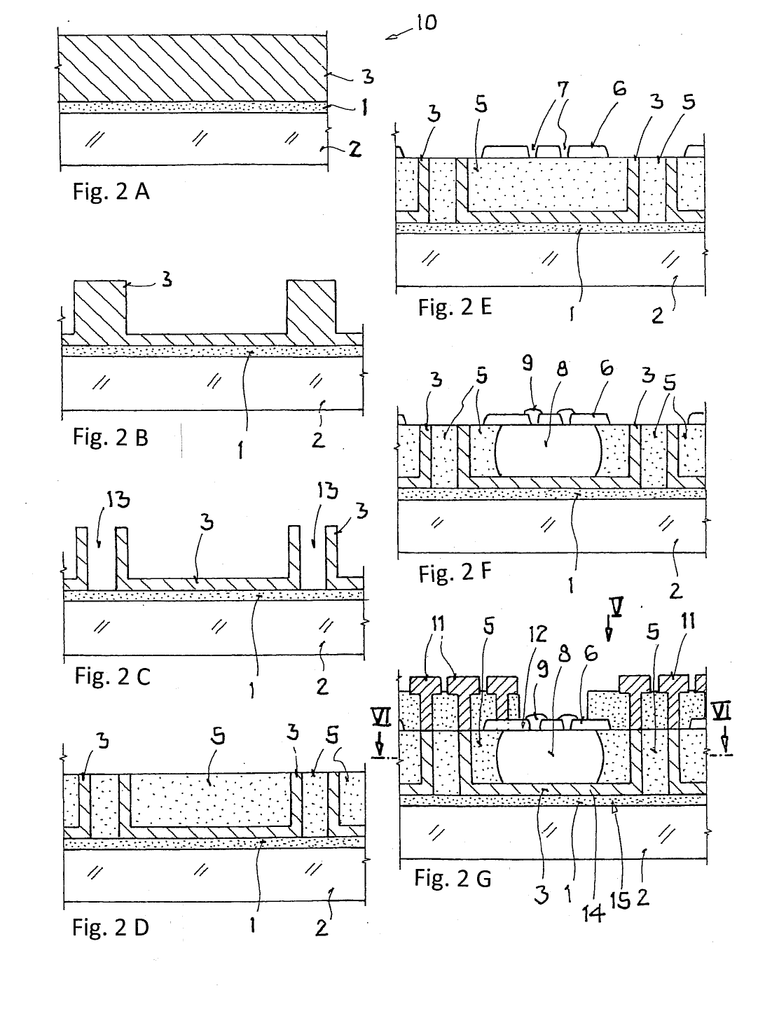

FIGS. 2a through 2g show the same standard process sequence as in the production of the component in FIG. 1a through FIG. 1g. However, as is evident from FIG. 2c, deep trenches 13 reaching down to the first insulating layer 1′are etched during the staggered back-etching of the first conductive layer 3. These deep trenches 13 are filled in again when the second insulating layer 5 is deposited. As is evident from FIG. 2g, the trenches 13 divide the bottom electrode 14, which results from the structured first conductive layer 3, into separate electrically insulated segments 15, which can also be electrically contacted separately.

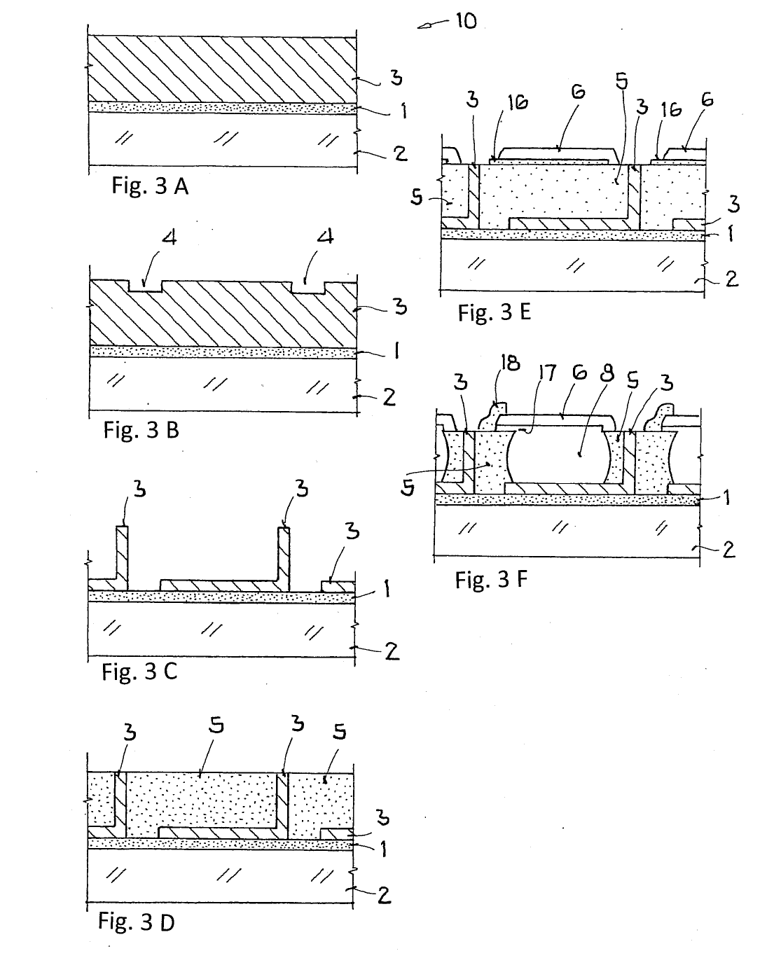

FIGS. 3a through 3d also show the process sequences known from the aforementioned figures. However, as is evident from FIG. 3e, an additional thin insulating layer 16 is deposited in subregions before the deposition of the second conductive layer 6 on the second insulating layer 5. In applying the second conductive layer 6, care is taken to ensure that it does not fully cover the thin insulating layer 16, but instead permits access from the side, for example. In the subsequent etching process, the thin insulating layer 16 is first etched into subregions so as to form thin channels 17 between the second conductive layer 6 and second insulating layer 5 that allow the etching solution to penetrate under the second conductive layer 6, firstly producing a hollow space 8 and secondly producing a membrane from the second conductive layer 6. As is evident from FIG. 3f, after the etching of the hollow space 8 the channels 17 are sealed by the deposition of a sealing material 18, for example an insulator, on the edge of the cover layer 6.

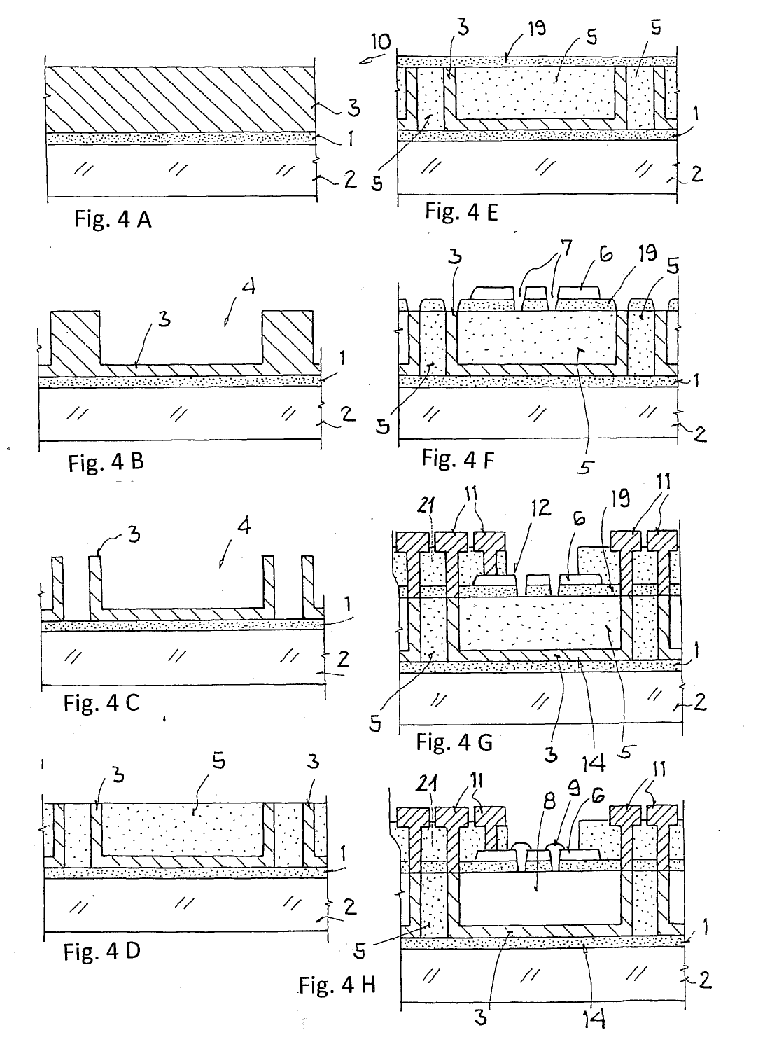

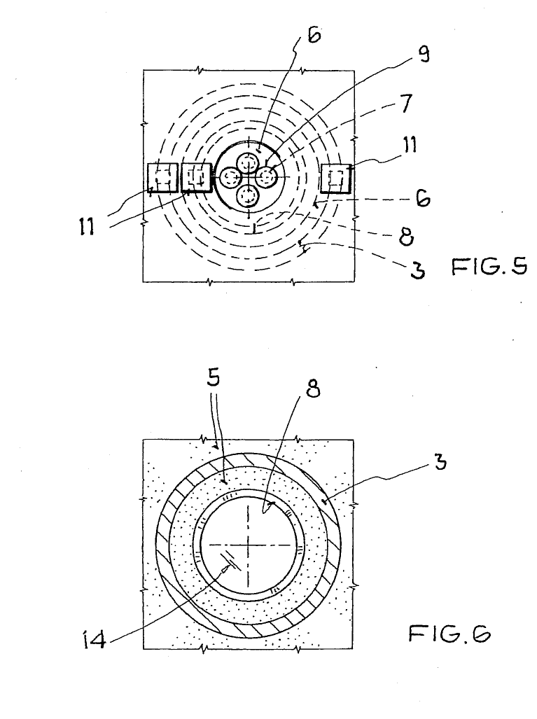

It is evident from an example embodiment shown in FIGS. 4a through 4i that the later membrane can not only include the conductive layer 6, as shown in FIGS. 1e, 2e and 3e, but can also include an additional passivation or insulating layer 19. FIG. 4f shows that an additional conductive layer 6 must be applied on the passivation or insulating layer 19 to produce the top electrode and its electrical contact 11. Next, both the conductive layer 6 and the passivation or insulating layer 19 are etched in a structured manner to produce the etch openings 7. The production of the electrical contact 11 can take place thereafter, but before the etching of the hollow space 8, as shown in FIG. 4g. This has the advantage that the method can be integrated in one production process without the need to be careful of a movable membrane, which can otherwise be damaged during the further process steps. As can be seen from FIG. 4h, the etching can encompass the entire area under the later membrane, since adequate electrical insulation to the side walls and the bottom electrode 14 of the microelectromechanical component is ensured by the passivation or insulating layer 19.

As an alternative to an additional passivation or insulating layer 19, the second insulating layer 5 can be made sufficiently thick that it covers the structured first conductive layer 3. The production of the hollow space 8 can then take place through controlled etching of the second insulating layer 5 with an etch stop such that a movably suspended membrane remains from the second insulating layer 5 over the hollow space 8. In this case as well, an additional conductive layer 6 must be deposited on the later membrane in order to produce the top electrode.

FIG. 5 shows a top view of a microelectromechanical component. The design of the MEMS component shown is provided with a movable membrane that includes the second conductive layer 6. For example, the MEMS component can serve as an ultrasonic source (CMUT, capacitive micromechanic ultrasonic transducer) by inducing a membrane deflection.

In order to capacitively detect a membrane deflection, for example for a pressure or acoustic sensor, it is advantageous in the transmitter to also design the bottom electrode 14, which includes the first conductive layer 3, with a large area, since the capacitive signal is area-dependent and a higher signal output can be obtained for equal pressure with larger electrodes than with small electrodes.

FIG. 6 shows a cross section through a microelectromechanical component according to an embodiment from FIG. 5. For the electrical contact 11 to the bottom electrode 14, the conductive layer 3 is routed annularly on the surface of the semiconductor component, where an electrical contact 11 takes place, for example by means of metal traces. Alternatively, it is also possible to structure columnar sections of the first conductive layer 3 and use them to establish the connection to the bottom electrode 14.

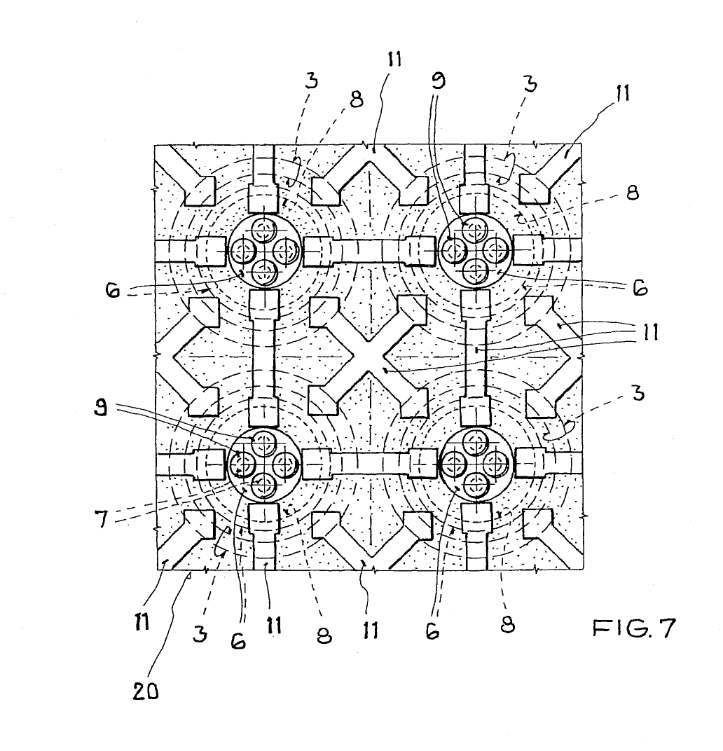

FIG. 7 shows a top view of several interconnected MEMS components, which form an array 20 and thus can produce a summed signal. The individual MEMS components are meshed together through the metallization layer, which also forms the electrical contact 11. In contrast thereto, a meshing of the top electrodes 12 through the second conductive layer 6 would also be possible. Not shown is the plane of the bottom electrodes 14, which are meshed together in like manner. In principle, the electrodes 12, 14 can be produced with any desired shape, for example round, square, rectangular, or octagonal. The meshing of the electrodes 12, 14 can also take place with different grids, for example square or hexagonal.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for producing integrated microelectromechanical components, the method comprising:
providing a first conductive layer on a first insulating layer;
structuring the first conductive layer;
providing a second insulating layer;
providing a second conductive layer;
providing at least one etch opening for at least partial etching of the second insulating layer beneath the second conductive layer in order to produce at least one hollow space; and
electrically contacting at least a portion of the first conductive layer and the second conductive layer.

2. The method according to claim 1, wherein the at least one etch opening is produced in the second conductive layer.

3. The method according to claim 1, wherein the at least partial etching of the second insulating layer under the second conductive layer takes place after the electrical contacting of the first and second conductive layers.

4. The method according to claim 1, wherein the at least one etch opening is closed.

5. The method according to claim 1, wherein the first insulating layer is produced on a substrate layer.

6. The method according to claim 1, wherein the structuring of the first conductive layer takes place in multiple, staggered, steps.

7. The method according to claim 1, wherein the structuring of the first conductive layer involves subregions of this layer in the full thickness thereof to the first insulating layer.

8. The method according to claim 1, wherein a highly doped material is used as the starting material for the first conductive layer.

9. The method according to claim 1, wherein metal is used as the starting material for the first conductive layer.

10. The method according to claim 1, wherein a doping of the first conductive layer takes place after the application on the first insulating layer in another process step.

11. The method according to claim 1, wherein a doping of the first conductive layer takes place after the structuring of the layer.

12. The method according to claim 1, wherein the surface of the second insulating layer is leveled after the deposition process.

13. The method according to claim 1, wherein prior to deposition of the second conductive layer, an insulating layer is deposited that extends over the second conductive layer at least in subregions.

14. The method according to claim 13, wherein an etch opening is produced by the etching of the insulating layer present in the subregions.

15. The method according to claim 1, wherein, after the production of a hollow space in the second insulating layer, a complete or partial passivation of the hollow space takes place by introduction of a gas or liquid through etch openings.

16. The method according to claim 15, wherein a defined internal pressure is produced in the hollow spaces during sealing of the etch openings.

17. The method according to claim 1, wherein additional material is deposited on the second conductive layer at a later time.

18. A microelectromechanical component comprising:
at least two insulating layers;
at least two conductive layers, wherein a conductive layer is located on an insulating layer; and
at least one membrane being provided over at least one hollow space, the hollow space being provided at least partially in the second insulating layer.

19. The microelectromechanical component according to claim 18, wherein the electrical contacting of the two conductive layers takes place from one side.

20. The microelectromechanical component according to claim 18, wherein connections to connect multiple microelectromechanical components into an array are provided in the conductive layers.
